(19) United States
(12) Patent Application Publication
(10) Pub. No.: US 2006/0191106 A1
(43) Pub. Date: Aug. 31, 2006

(54) Manual window-raising implement

(76) Inventor: William P. Barbour, St Augustine, FL (US)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 11/066,770

(22) Filed: Feb. 28, 2005

(51) Int. Cl. E05B 1/00

(52) U.S. Cl. 16/413

(57) ABSTRACT

A manual window-raising implement includes upper and lower hook portions forming a downwardly open recess, and an upwardly open recess, respectively. The upper recess has a width large enough to receive a fingertip of a user and has a length of at least two inches for receiving a plurality of the user's fingertips. The lower recess is wide enough to receive a vertical lip of a slidable window panel, so that by applying an upward force to the upper hook portion, the window panel can be raised.

### BACKGROUND OF THE INVENTION

The present invention relates to windows, especially high-wind-resistant windows, and is particularly directed to methods and apparatus for raising a slidable window panel.

In areas that are particularly susceptible to high winds, e.g., from hurricanes, residents have provided homes, offices, etc. with special hurricane-resistant single/double-hung windows in an effort to resist window damage caused by the high winds. The windows, which include a rectangular metal frame in which the glazing is mounted, have a tendency to fit so tightly within the fixed frame in which the window is mounted, that it has become difficult for people, especially the elderly, to raise a closed window, especially larger windows having a width of four feet or more.

Accordingly, it would be desirable to provide a device that would facilitate the raising of windows, especially of the hurricane-resistant type.

### SUMMARY OF THE INVENTION

One aspect of the invention pertains to a manual window-raising implement which comprises upper and lower hook portions joined by a connector portion. The lower hook portion forms an upwardly open first recess. The upper hook portion forms a downwardly open recess having a width large enough to receive a fingertip of a user. The upper recess has a length of at least two inches. The implement is manipulable to engage a bottom lip of a window frame in the lower recess while manually pulling upwardly on the upper hook portion by fingertips positioned within the upper recess, to raise the window.

Another aspect of the invention relates to a method of opening a vertically slidable window panel that comprises a rectangular sliding frame in which glazing is mounted. The sliding frame is slidably mounted in a fixed frame which includes a vertical interior flange extending horizontally along a bottom side of the fixed frame. The sliding frame includes an interiorly projecting ledge extending horizontally along a bottom side of the sliding frame, and a lip projecting downwardly from an interior edge of the ledge, wherein the lip is spaced interiorly of the vertical flange of the fixed frame by a first distance. The method utilizes a manual implement which comprises upper and lower hook portions joined by a connector portion. The lower hook portion forms an upwardly open first recess having a width greater than a thickness of the lip. The upper hook portion forms a downwardly open recess having a width greater than the distance by which the lip is spaced from the vertical flange and great enough to receive a fingertip of a user. The upper recess has a length of at least two inches. The method comprises the steps of:

A. manipulating the implement to cause the lip to be inserted into the lower recess; and

B. with the user's fingers inserted in the upper recess, applying an upward force to the implement.

### BRIEF DESCRIPTION OF THE DRAWINGS

The objects and advantages of the invention will become apparent from the following detailed description of preferred embodiments thereof in connection with the accompanying drawings in which like numerals designate like elements and in which:

FIG. 1 is an elevational view of a conventional window having a vertically slidable panel and which is viewed from the interior of a room in which the window is mounted.

FIG. 2 is a sectional view taken along the line 2-2 in FIG. 1.

FIG. 3 is a side elevational view of an implement according to the present invention.

FIG. 4 is an end view of the implement shown in FIG. 3.

FIG. 5 is a view similar to FIG. 2 showing how the implement would be manipulated to raise the sliding panel.

FIG. 6 is a view similar to FIG. 4 of an alternative implement configuration.

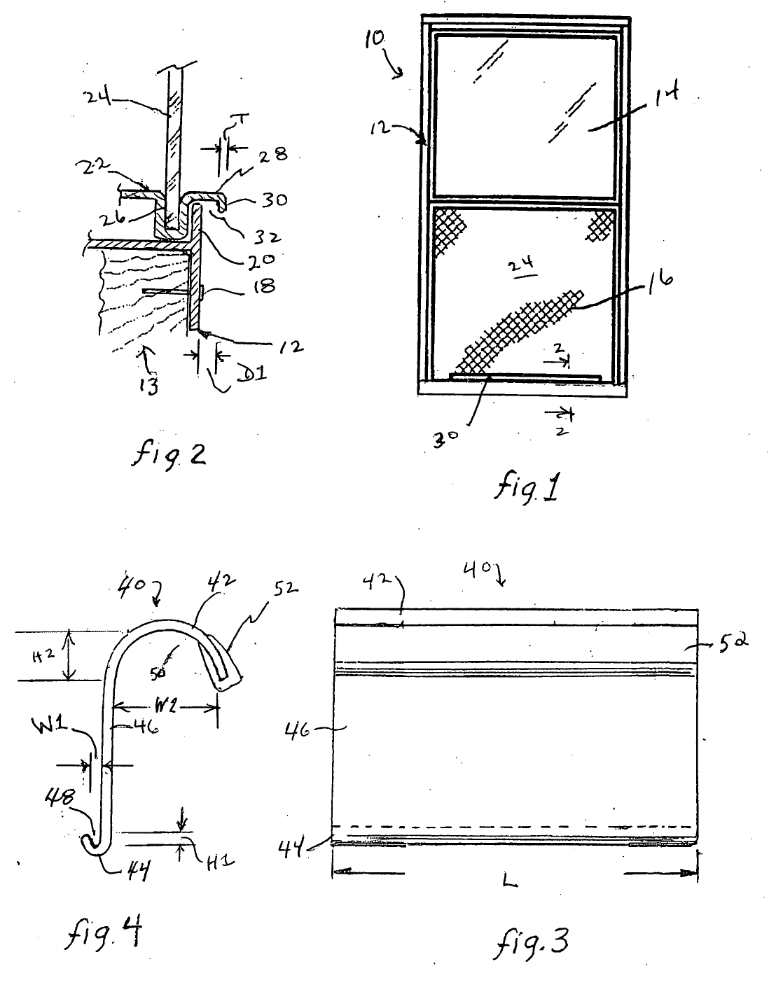

### DETAILED DESCRIPTION OF PREFERRED EMBODIMENTS OF THE INVENTION

Depicted in FIG. 1 is a window assembly 10 which includes a fixed frame 12 in which are mounted upper and lower glass panels 14, 16. At least the lower pane 16 is vertically slidable between open and closed positions. That is, the window could be single or double hung.

The fixed frame 12 is attached to a wall 13, e.g., by fasteners 18, and includes a horizontal bottom side that forms a vertical interior flange 20. By “interior” is meant that the flange is situated inside of the room in which the window assembly 10 is disposed.

The vertically slidable lower glass panel 16 includes a slidable frame 22 and glazing 24 mounted in an upwardly open channel 26 disposed along a horizontal bottom side of the slidable fame. An interiorly disposed ledge 28 extends horizontally along at least a portion of the bottom side of the sliding frame 22, and a lip 30 projects downwardly from an interior edge of the ledge to define a downwardly open groove 32. The lip 30 is spaced interiorly of the vertical flange 20 by a distance D1.

When a user wishes to raise the lower panel 16, he/she must insert his/her fingers into the groove 32 and pull upwardly. Typically, the distance D1 is insufficient for the user's fingertips to fit comfortably within the groove 32, and it is difficult for the user to apply a large upward force to the lower panel 16. Thus, if the lower panel 16 presents an appreciable resistance to upward movement, as is often the case, for example, with hurricane-resistant windows that fit tightly within the fixed frame 12, then the user, especially children and the elderly, may be unable to raise the window.

In accordance with the present invention, a manual window-raising implement 40 is provided which eliminates the above-discussed problem. The implement comprises a body forming upper and lower hook portions 42, 44 joined by a connector portion 46. The lower hook portion 44 forms an upwardly open lower recess 48 having a width W1 greater than the thickness T of the lip 30. The upper hook portion 42 forms a downwardly open upper recess 50 having a width W2 greater than the distance D1 and large enough to receive a fingertip T of a user, e.g., at least one inch. The upper recess 44, and thus the upper hook portion 42, has a length L great enough to receive four fingers of a user, e.g., at least two inches, but preferably at least three inches or longer.

The height H1 of the lower recess 48 is shorter than the height H2 of the upper recess 50.

To open a panel, an implement 40 is held in each of the user's hands and each implement is manipulated such that the lip 30 is received in the lower recess 48. With the user's fingertips of each hand inserted into the downwardly open recess 50 of a respective implement 40, the user applies a generally upwardly directed force to raise the panel.

Preferably, the implement is shaped so that when the lip is received in the lower recess 48, the connector portion 46 can be oriented substantially vertically, i.e., generally in the direction in which the user pulls, so that the connector portion is placed in tension with little bending movement imparted thereto.

Preferably, a flexible cover 52 is attached to the free end of the upper hook 42 for the comfort of the user, the cover being formed of rubber or plastic, for example, which is softer than the body of the implement. The rest of the implement (i.e., the body) can be formed of any suitably strong material, such as steel, extruded aluminum or high-strength plastic.

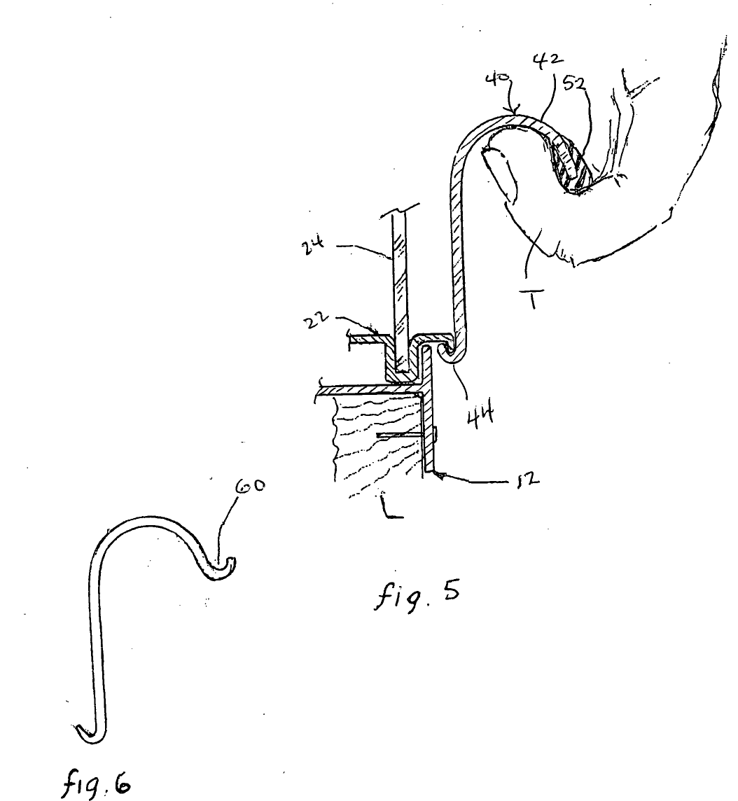

Alternatively, the tip or free end 60 of the upper hook portion could be reversely curved as shown in FIG. 6 to provide comfort to the user.

Although the connector portion 46 has been shown as extending continuously along the length L, the connector portion could instead be formed of a plurality of narrow strips, or even wires, since the only function thereof is to transmit a vertical force.

While it has been disclosed to employ two short implements 40 (one for each of the user's hands), there could instead be provided a single long implement that can accommodate both hands, spread apart.

It will be appreciated that the invention guarantees that a user will be able to apply a raising force in an effective, comfortable manner, regardless of the magnitude of the distance D1. The invention is especially suited for opening long windows, e.g., four feet in length, which can require the application of considerable force.

Although the present invention has been described in connection with a preferred embodiment thereof, it will be appreciated by those skilled in the art that additions, deletions, modifications, and substitutions not specifically described may be made without departing from the spirit and scope of the invention as defined in the appended claims.

What is claimed is:

1. A manually manipulable window raising implement comprising upper and lower hook portions joined by a connector portion; the lower hook portion forming an upwardly open first recess; the upper hook portion forming a downwardly open recess having a width large enough to receive a finger tip of a user; the upper recess having a length of at least two inches; wherein the implement is manipulable to engage a bottom lip of a window frame in the lower recess while manually pulling upwardly on the upper hook portion by finger tips positioned within the upper recess to raise the window.

2. The implement according to claim 1 wherein the connector portion extends continuously along the length of the implement.

3. The implement according to claim 1, further including a cover attached at a free end of the upper hook portion and formed of a softer material than the body of the implement.

4. The implement according to claim 1 wherein the width of the lower recess being shorter than the width of the upper recess.

5. The implement according to claim 1 wherein the width of the upper recess is at least one inch.

6. The implement according to claim 1 wherein the length of the upper recess is at least two inches.

7. The implement according to claim 1 wherein a height of the lower recess is less than that of the upper recess.

8. The implement according to claim 1 wherein a free end of the upper hook portion is reversely curved.

9. A method of opening a vertically slidable window panel that comprises a rectangular sliding frame in which glazing is mounted, the sliding frame being slidably mounted in a fixed frame which includes a vertical interior flange extending horizontally along a bottom side of the fixed frame; the sliding frame including an interiorly projecting ledge extending horizontally along a bottom side of the sliding frame, and a lip projecting downwardly from an interior edge of the ledge, wherein the lip is spaced interiorly of the vertical flange of the fixed frame by a first distance; the method utilizing a manual implement comprising upper and lower hook portions joined by a connector portion; the lower hook portion forming an upwardly open first recess having a width greater than a thickness of the lip; the upper hook portion forming a downwardly open recess having a width greater than the distance by which the lip is spaced from the vertical flange and great enough to receive a finger tip of a user; the upper recess having a length of at least two inches; the method comprising the steps of:
A. manually manipulating the implement to cause the lip to be inserted into the lower recess; and
B. with the user's fingers inserted in the upper recess, applying an upward force to the implement.

10. The method according to claim 9 wherein the connector portion is oriented substantially vertically during step B.

11. The method according to claim 9 wherein the user employs a separate implement in each hand.

12. The method according to claim 9 wherein the user carries a single implement with both hands.
